(19) United States
(12) Patent Application Publication
(10) Pub. No.: US 2020/0311727 A1
(43) Pub. Date: Oct. 1, 2020

(54) HYBRID PROCESSING FOR ACCESS DEVICE TRANSACTIONS

(71) Applicant: Visa International Service Association, San Francisco, CA (US)

(72) Inventor: Gregory Paul Loomis, Fremont, CA (US)

(21) Appl. No.: 16/820,506

(22) Filed: Mar. 16, 2020

Related U.S. Application Data
(60) Provisional application No. 62/823,408, filed on Mar. 25, 2019.

(51) Int. Cl. G06Q 20/40; G06Q 20/42; G06Q 20/10

(52) U.S. Cl. CPC G06Q 20/401; G06Q 20/108; G06Q 20/42

(57) ABSTRACT

Embodiments are directed to processing an access device transaction using a hybrid processing that jointly authorizes and settles the transaction. An account holder may initiate the transaction at the access device of a resource provider by presenting a payment device. The access device retrieves account credentials directly from the payment device and transmits them to a resource provider computer. The resource provider computer or a transport computer initiates a hybrid request that requests joint authorization and settlement of the transaction. Upon approval from the authorizing authority, the transaction is authorized and settled within single message stream. An account of the resource provider is credited in an amount authorized by the authorizing authority in real time (e.g. within 1 to 60 minutes of completing the transaction). The hybrid processing eliminates the subsequent clearing and settlement process as the transaction is already cleared and settled.

### CROSS-REFERENCES TO RELATED APPLICATIONS

This application claims benefit under 35 USC§ 119(e) to U.S. Provisional Patent Application No. 62/823,408 filed Mar. 25, 2019, which is incorporated by reference herein in its entirety for all purposes.

### BACKGROUND

Conventional systems can transfer value from one user to another user. For example, in a conventional system for processing transactions, a first entity (e.g. an account holder) may wish to conduct a transaction with a second entity (e.g. a merchant) using a payment device associated with an account of the first entity. As part of the transaction, the first entity may wish to transfer funds for the transaction from their account to an account of the second entity. There may be additional intermediary entities that facilitate the transfer of the funds, such as a transport entity (e.g. an acquirer), a processing entity (e.g. a transaction processing network), and/or an authorizing entity (e.g. an issuer of the account). One or more of these entities may perform an authentication and/or authorization process before approving the transfer of the funds. In conventional systems, the transfer of the funds can take anywhere from 24 hours to up to 3-4 days. The delay between the transaction time/date and the funds transfer is undesirable for the merchants.

There is a need to improve conventional payment processes such as the kind descried above.

Embodiments address these and other problems, individually and collectively.

### BRIEF SUMMARY

Embodiments of the invention are directed to systems and methods that allow for hybrid processing of an access device transaction (e.g. a transaction initiated at an access device that retrieves account holder and/or account credentials directly from a payment device) between a consumer and a resource provider at an authorizing authority. The hybrid processing may refer to the joint authorization and settlement of the transaction. When the transaction is authorized for hybrid processing by the authorizing authority, the authorizing authority returns a hybrid response message authorizing the transaction and instructing the transport computer to credit an account of the resource provider in real time. According to various embodiments, a access device transaction may be processed by a processing entity or an authorizing authority (e.g. issuer) as an original credit transaction (OCT) where funds are provided to the resource provider (e.g. a merchant) in real time (e.g. a predetermined amount of time such as 1 min, 15 min, 30 min, or 60 min after the resource provider delivers goods or services to the consumer).

One embodiment of the invention includes a method comprising receiving, at a transport computer from a computer of a resource provider, information associated with a transaction initiated at an access device associated with the resource provider. The method further includes identifying, by the transport computer, that the resource provider and the transaction are eligible for joint processing for authorization and settlement. The method also includes generating, by the transport computer, a hybrid request message including a request to authorize and settle the transaction in a single message. The method includes transmitting, by the transport computer, the hybrid request message a processing server computer. In addition, the method includes receiving, by the transport computer, a response message including an indicator that the transaction is authorized by an authorizing authority computer. The transport computer then transmits an authorization response message including the indicator that the transaction is authorized to the computer of the resource provider. The method further includes settling, by the transport computer, with the resource provider.

Another embodiment of the invention is directed to a method comprising receiving, at an authorizing authority computer, a hybrid request message requesting approval for a transaction between an account holder and a resource provider. The hybrid request message includes a request for joint authorization and settlement for the transaction. The method further include determining, by the authorizing authority computer, that one or more of the transaction, the account holder or the resource provider do not qualify for joint authorization and settlement processing. The method includes authorizing, by the authorizing authority computer, the transaction and generating, by the authorizing authority computer, an authorization response message including an identifier indicating that the transaction is authorized. The authorizing authority computer transmits the authorization response message to a transport computer in communication with a computer of the resource provider.

Other embodiments of the invention are directed to server computers and systems that can be configured to perform the above-noted methods.

These and other embodiments of the invention are described in further detail below.

### BRIEF DESCRIPTION OF THE DRAWINGS

FIG. 1 shows a block diagram of a system processing transactions using conventional techniques.

FIG. 2 is a block diagram of an exemplary system for hybrid processing of access device transactions according to various embodiments of the present invention.

FIG. 3 is a flowchart of an exemplary method for hybrid processing of access device transactions according to various embodiments of the present invention.

FIG. 4 is a block diagram of an exemplary system for hybrid authorization request of access device transactions according to various embodiments of the present invention.

FIG. 5 is a flowchart of an exemplary method for hybrid authorization request of access device transactions according to various embodiments of the present invention.

FIG. 6 is a block diagram of an exemplary transport computer according to various embodiments of the present invention.

FIG. 7 is a block diagram of an exemplary processing network server according to various embodiments of the present invention.

FIG. 8 is a block diagram of an exemplary authorizing authority computer according to various embodiments of the present invention.

### DETAILED DESCRIPTION

Prior to discussing various embodiments, some terms can be described in further detail.

A “user” may include an individual. In some embodiments, a user may be associated with one or more personal accounts and/or payment devices. The user may also be referred to as a cardholder, account holder, or consumer in some embodiments.

A “payment device” may be a compact and handheld portable device operated by a user. The payment device may be small enough to fit into a wallet, pocket, or purse. The payment device may be associated with a payment account issued by an authorizing authority or an issuer. Examples of payment devices may include payment cards such as credit cards, smart cards, gift cards, payroll cards, healthcare cards, a discount or loyalty card. A payment device may be used by a user as part of an authentication or authorization process. For example, a user may present a payment device to an access device in order to authenticate the user, or a user may present a payment device at an access device (e.g. a point of sale terminal) as part of performing a transaction with a merchant. A payment device may possess a payment card interface, enabling the payment device to communicate with other devices, such as access devices, point of sale terminals, or enrollment devices. A payment device may include a volatile or a non-volatile memory to store information. A payment device may possess a biometric device, enabling the payment device to collect biometric information, such as fingerprints or thumbprints.

An “access device” may be any suitable device that provides access to a remote system. An access device may also be used for communicating with a resource provider computer, a processing server computer, or any other suitable system. An access device may generally be located in any suitable location, such as at the location of a resource provider or merchant. An access device may be in any suitable form. Some examples of access devices include POS or point of sale devices (e.g., POS terminals), cellular phones, PDAs, personal computers (PCs), tablet PCs, hand-held specialized readers, set-top boxes, electronic cash registers (ECRs), automated teller machines (ATMs), virtual cash registers (VCRs), kiosks, security systems, access systems, terminals, and the like. An access device may use any suitable contact or contactless mode of operation to send or receive data from, or associated with, a payment device. In some embodiments, where an access device may comprise a POS terminal, any suitable POS terminal may be used and may include a reader, a processor, and a computer-readable medium. A reader may include any suitable contact or contactless mode of operation. For example, exemplary card readers can include radio frequency (RF) antennas, optical scanners, bar code readers, or magnetic stripe readers to interact with a payment device and/or mobile device. Other examples of access devices include devices (e.g., locks, gates, access control boxes, etc.) that control physical access to locations (e.g., venues, transit stations, homes, offices, buildings, etc.), as well as software devices that control access to data or information.

A “resource provider” may be an entity that can provide a resource such as goods, services, information, and/or access. Examples of resource providers includes merchants, data providers, transit agencies, governmental entities, venue and dwelling operators, etc. A resource provider may operate a resource provider computer.

A “merchant” may typically be an entity that engages in transactions and can sell goods or services, or provide access to goods or services.

An “authorizing authority” may be an entity that authorizes a request. Examples of an authorizing authority may be an issuer, a governmental agency, a document repository, an access administrator, etc. An authorizing authority may operate an authorizing authority computer.

An “issuer” may typically refer to a business entity (e.g., a bank) that maintains an account for a user that is associated with a portable communication device such as an account enrolled in a mobile application installed on a portable communication device. An issuer may also issue account parameters associated with the account to a portable communication device. An issuer may be associated with a host system that performs some or all of the functions of the issuer on behalf of the issuer.

A “processing server computer” may include a server computer used for processing transactions from a network. In some embodiments, the processing server computer may be coupled to a database and may include any hardware, software, other logic, or combination of the preceding for servicing the requests from one or more client computers or user devices. The processing server computer may comprise one or more computational apparatuses and may use any of a variety of computing structures, arrangements, and compilations for servicing the requests from one or more client computers or user devices. In some embodiments, the processing server computer may operate multiple server computers. In such embodiments, each server computer may be configured to process a transaction for a given region or handles transactions of a specific type based on transaction data.

The processing server computer may include data processing subsystems, networks, and operations used to support and deliver authorization services, exception file services, and clearing and settlement services. An exemplary processing server computer may include VisaNet™. Networks that include VisaNet™ are able to process credit card transactions, debit card transactions, and other types of commercial transactions. VisaNet™, in particular, includes an integrated payments system (Integrated Payments system) which processes authorization requests and a Base II system, which performs clearing and settlement services. The processing server computer may use any suitable wired or wireless network including the Internet.

The processing server computer may process transaction-related messages (e.g., hybrid request messages, authorization request messages, hybrid response messages and authorization response messages) and determine the appropriate destination computer (e.g., issuer computer/authorizing authority computer) for the transaction-related messages. In some embodiments, the processing server computer may authorization transactions on behalf of an issuer. The processing server computer may also handle and/or facilitate the clearing and settlement of financial transactions.

“Authorization processing” or “authorization operations” may include at least determining whether to authorize a transaction. Authorization processing may be executed responsive to receiving a notification that a prior step in a transaction has been completed. Alternatively, or additionally, authorization processing may include generating and sending an authorization request message and/or authorization response message.

A “hybrid request message” may be an electronic message that requests joint processing for authorization and settlement of a transaction. In some embodiments, it is sent to a processing server computer and/or an issuer of a payment card to request authorization and settlement for a transaction. The hybrid request message may include a hybrid message type indicator (e.g. an indicator indicating the message as a hybrid processing request). For example, the hybrid message type indicator may include a hybrid processing code indicating a request for joint processing for authorization and settlement. The hybrid processing code is different from a normal authorization request code which requests for authorization (without the settlement) of the transaction. The hybrid request message may also include an account identifier (e.g. a virtual primary account number (vPAN)) assigned to a resource provider by the processing entity, and identifying an account of the resource provider. The hybrid request message may further include credentials retrieved directly from a payment device by an access device during the transaction. The credentials may identify an account issued by the authorizing authority (e.g. an issuer) and associated with the payment device. The credentials may include, by way of example only: a service code, a CVV (card verification value), a dCVV (dynamic card verification value), a PAN (primary account number or “account number”), a payment token, a user name, an expiration date, etc. The hybrid request message may also comprise “transaction information,” such as any information associated with a current transaction, such as the transaction amount, merchant identifier, merchant location, acquirer bank identification number (BIN), card acceptor ID, information identifying items being purchased, etc., as well as any other information that may be utilized in determining whether to identify and/or authorize a transaction. A hybrid request message, according to some embodiments, may comply with International Organization for Standardization (ISO) 8583, which is a standard for systems that exchange electronic transaction information associated with a payment made by a user using a payment device or payment account.

An “authorization response message” may be a message that responds to a hybrid request. In some cases, it may be an electronic message reply to the hybrid request message generated by an issuing financial institution or a processing server computer. The authorization response message may include a standard message type indicator (e.g. an indicator indicating the message as an authorization response message). For example, the issuing financial institution may determine that the transaction and/or the account identified in the hybrid request may not qualify for hybrid processing. In such cases, the issuing financial institution may respond to the hybrid request with an authorization response message. The authorization response message may include, by way of example only, one or more of the following approval response codes: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the processing server computer) to the merchant's access device (e.g. point of sale equipment) that indicates approval of the transaction. The code may serve as proof of authorization.

A “hybrid response message” may be a message that responds to a hybrid request. In some cases, it may be an electronic message reply to the hybrid request message generated by an issuing financial institution or a processing server computer. The hybrid request message may include a hybrid message type indicator (e.g. an indicator indicating the message as a hybrid processing response, that the issuer considers the transaction as cleared and settled). For example, the hybrid message type indicator may include a hybrid processing code indicating that the transaction is authorized and considered settled. The hybrid processing code is different from a normal authorization response code which indicates the status of authorization (e.g. declined or authorized without the settlement) of the transaction. The hybrid response message may include, as a differentiator from the authorization response message, an instruction for the transport entity to settle with the resource provider (e.g. to credit an account of a resource provider in an authorized amount). For example, the instruction may be in form of a code or an indicator provided at a predetermined data field of the hybrid response message, that, when processed by a computer of the transport entity, will trigger the transport entity to credit an account of the resource provider in an amount approved by the authorizing authority. For example, the hybrid response message may include the amount approved by the authorizing entity. Alternatively, the hybrid response message may include a code that will identify the credit amount to be equal to the transaction amount. The hybrid response message may include additional data similar to the authorization response message. For example, the hybrid response message may include, by way of example only, one or more of the following approval response codes: Approval—transaction was approved; Decline—transaction was not approved; or Call Center—response pending more information, merchant must call the toll-free authorization phone number. The hybrid response message may also include an authorization code, which may be a code that a credit card issuing bank returns in response to an authorization request message in an electronic message (either directly or through the processing server computer) to the merchant's access device (e.g. point of sale equipment) that indicates approval of the transaction. The code may serve as proof of authorization.

The term “authentication” and its derivatives may refer to a process by which the credential of an endpoint (including but not limited to applications, people, devices, processes, and systems) can be verified to ensure that the endpoint is who they are declared to be.

“Transaction data” or “transaction details” may refer to information associated with a transaction. For example, transaction data may include one or more of an authorized amount (e.g., transaction amount, item value, etc.), other amount, terminal country code, terminal verification results, transaction currency code, transaction date, transaction type (e.g., card-present transaction, card-not-present transaction, high value transaction, low value transaction, local transaction, international transaction, etc.), an unpredictable number, application interchange profile (AIP), application transaction counter (ATC), issuer application data (IAD), etc.

The term “message” may include any data or information that may be transported from one entity to another entity (e.g., one computing device to another computing device). Messages may be communicated internally between devices/components within a computer or computing system or externally between devices over a communications network. Additionally, messages may be modified, altered, or otherwise changed to comprise encrypted or anonymized information.

A “notification” may include a message that can be sent to an entity to provide information to the entity, such as a status associated with an event. The notification may include additional information about the event such as a time, date, a description of the event, participants of the event, etc. In some embodiments, a notification or notification message may inform an entity that the entity should perform one or more operations in association with an event.

A “processor” may refer to any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer-readable medium that stores instructions that can be executed by a processor to implement a desired method. Examples of memories may comprise one or more memory chips, disk drives, etc. Such memories may operate using any suitable electrical, optical, and/or magnetic mode of operation.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

An “Original Credit Transaction (OCT)” may include a clearing and settlement credit transaction designed for use in business applications such as a business money transfer or business-to-consumer repayments. A special indicator identifies an OCT to the recipient of the message. OCT messages may also include an Electronic Commerce Indicator (ECI) to indicate an Internet OCTs (if appropriate). Representational State Transfer Extensible Markup Language (REST-XML), REST-JavaScript Object Notation (REST-JSON), and REST-Name-Value-Pairs (REST-NVP) templates may be used for the OCT request messages. OCT request messages described herein may include an amount associated with the transfer of funds, an account identifier of the recipient, an account identifier of a user, supplemental information of the user, a message type indicator, a transaction identifier, currency information and any other appropriate information.

When used in the context of embodiments of the present invention, an OCT can be a transaction used to credit an account of a resource provider in an amount approved by an authorizing authority (e.g. a transaction amount) in real time or shortly after a transaction has been initiated (e.g. the resource provider may receive funds within 1 minute, 5 minutes, 15 minutes, 30 minutes, or 60 minutes of completing the transaction (e.g. providing the goods or services to the user)).

The amount of the OCT is the amount agreed by the sender (e.g. user, consumer conducting a transaction with a resource provider) and the resource provider in the currency agreed. If the recipient's billing currency is different from the currency agreed at the transaction time, currency conversion is performed on the OCT and the exact amount credited to the recipient account will not be known at transaction time. In some embodiments, the OCT carries only the account number of the recipient and no information about the sender. A special indicator identifies an OCT to the recipient's issuer bank. Interchange can flow from the submitting acquirer to the recipient's issuer, as in a normal purchase transaction. Settlement can take place within a few minutes or a few hours.

According to various embodiments, a user (e.g. a consumer, a cardholder) may initiate a transaction at an access device (e.g. a transaction terminal, a point of sale (POS) terminal) of a resource provider (e.g. a merchant). The user may present a payment device to the access device. The transaction may be processed according to conventional methods where an account of the merchant is credited in an amount of the transaction (or an amount authorized by the issuer) within one or more days. Alternatively, the access device transaction may be processed using OCT processing.

According to embodiments of the present application, the OCT processing of an access device transaction may include a transport computer generating a single message with a request for joint processing of authorization and settlement of the transaction. The single message (e.g. a hybrid message for authorization and settlement) is forwarded to and authorizing authority computer via a transaction processing server computer. In essence, the hybrid request message requests OCT processing for the access device transaction. The authorizing authority computer may determine whether the authorization and settlement for the transaction can be processed jointly. If the authorizing authority computer determines that the transaction qualifies for joint processing, the authorizing authority will generate a hybrid response including an indicator that the transaction is authorized and an instruction to the transport computer to credit an account of the resource provider in the amount of the transaction or in an alternative amount that is authorized by the authorizing authority computer. If the authorizing authority computer determines that the transaction does not qualify for joint processing, the authorizing authority will generate an authorization response message authorizing (or potentially declining) the transaction. The transport computer will then initiate the settlement process with the processing server computer or the authorizing authority within a few hours to a couple of days.

Conventional processing and hybrid processing (e.g. OCT processing) in access device transactions, and their differences, will be described next.

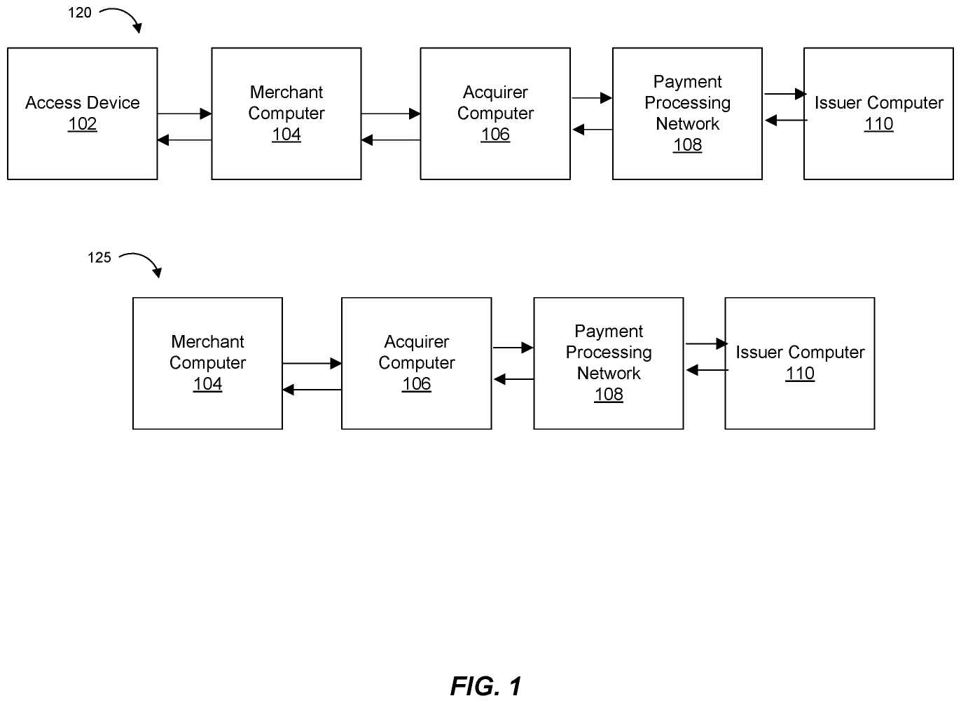

According to conventional systems, after the user initiates the transaction at an access device 102 associated with the merchant, a merchant computer 104 initiates a transaction authorization process for a card-present transaction since a physical payment device is provided to the merchant by the user. According to the conventional methods, the merchant account is credited for the transaction one or more days after the issuer has authorized the transaction. The conventional card-present transaction processing is illustrated in FIG. 1.

FIG. 1 illustrating the conventional card-present transaction processing includes 2 separate stages of processing. During the first stage, the user initiates the transaction at the access device 102. The access device 102 then transmits the transaction details to a merchant computer 104, which then transmits the transaction details to an acquirer computer 106. The access device 102 and the merchant computer 104 can be operated by a merchant. The acquirer computer 106, which is operated by an acquirer, generates a transaction authorization request and sends the transaction authorization request to a payment processing network 108. The payment processing network 108 may perform a predetermined set of steps associated with processing of the transaction and may transmit the transaction authorization request or a modified form thereof to an issuer computer 110, which may be operated by an issuer. The issuer computer 110 determines whether the transaction should be authorized or declined, and then generates a transaction authorization response including an indicator indicating whether the transaction is authorized or declined. The transaction authorization response is transmitted to the acquirer computer 106 via the payment processing network 108. The acquirer informs the merchant of the transaction authorization outcome, and if the transaction is authorized, the user receives goods or services paid for.

During the second stage, the merchant computer 104 transmits a periodic (e.g. daily) list of transactions to the acquirer computer 106 to receive payment from the issuer. The acquirer may be associated with a plurality of merchants and with a plurality of payment processing networks. The acquirer sorts all settlement requests received from the merchants, and submits batches of settlement requests to the associated payment processing network(s). A payment processing network then distributes each transaction in the batch of settlement requests received from the acquirer to the associated issuer. The issuer debits the user account and routes the payment to the payment processing network. Upon receiving the funds or instructions for settlement from the issuer, the acquirer credits the account of the merchant in the amount of authorized (e.g. approved) transactions. Finally, the merchant receives the funds for the goods or services provided to the user(s).

In order to process the transaction described above, the resource provider and the authorizing entity exchanges at least two message streams. In the first message stream 120, the merchant computer 104 sends a pull request (e.g. a transaction authorization request message) to the acquirer computer 106 to request funds for a transaction initiated using a physical payment card. The acquirer computer 106 may transmit the request to payment processing network 108, which then transmits the request to the issuer computer 110. The request essentially asks the issuer computer 110 to determine if the merchant can pull funds from an account associated with the physical payment card at a later time (e.g. the next day or in a few days) through a clearing and settlement cycle. The issuer computer 110 generates and sends a pull response (e.g. a transaction authorization response message) to the merchant computer 104 via the payment processing network 108 and then the acquirer computer 106.

In the second message stream 125 (which occurs a predetermined amount of time (e.g. end of the day, 24 hours later, at least 12 hours later) after the first message stream 120 is completed, the merchant computer 104 sends a clearing draft and/or a settlement report to the acquirer computer 106. The acquirer computer 106 may request payment for the transactions identified on the settlement report from the payment processing network 108, which then forwards the request to the issuer computer 110. The issuer computer 110 instructs the acquirer computer 106 to credit an account of the merchant in the amount of approved transactions.

Using the conventional process, it may take from 24 hours up to three days to completely process a transaction. That is, the merchant may receive the payment for the goods or services already provided to the user 1-3 days after the goods or services are provided.

Embodiments address this and other drawbacks of conventional systems by implementing real-time processing (e.g. OCT processing) for card-present transactions.

According to various embodiments described herein, the resource provider or the transport entity initiates a hybrid request that requests an authorizing authority to (1) authorize the transaction, and (2) if the transaction is authorized, settle the transaction by instructing the transport entity to credit an account of the resource providing entity in the amount of the transaction (or another amount that is authorized by the authorizing authority) in near real time or shortly after a transaction is initiated. That is, the resource provider or the transport entity requests the authorizing authority to process the transaction using the OCT processing. According to the embodiments, the resource provider may receive funds within 1 minute, 5 minutes, 15 minutes, 30 minutes, or 60 minutes of completing the transaction (e.g. providing the goods or services to the user). The hybrid request processing that is used in embodiments of the invention eliminates the conventional, later clearing and settlement process as the transaction is already cleared and settled. The hybrid request processing for a card-present transaction is described next.

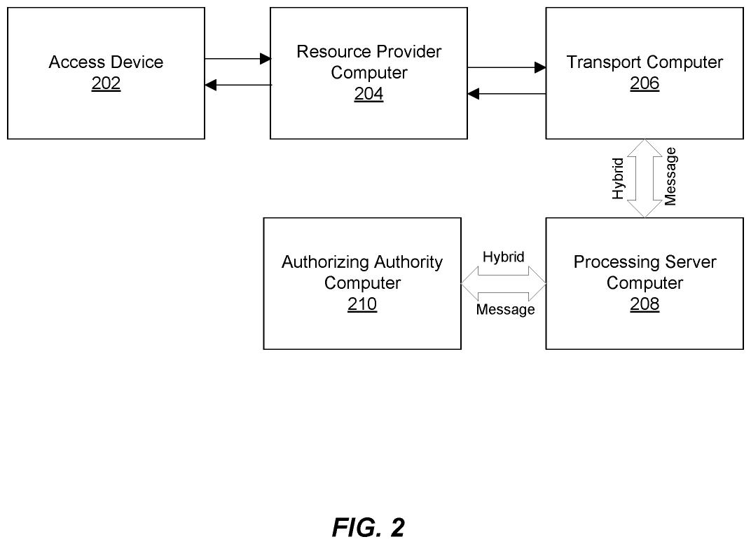

FIG. 2 illustrates a block diagram of an exemplary system for hybrid processing of access device transactions according to various embodiments of the present invention. A user may initiate a transaction with a resource provider by presenting a physical payment device to an access device (e.g. transaction terminal) associated with the resource provider. According to various embodiments, the payment device may include a payment card such as a credit card, a debit card, a loyalty card, a prepaid card, a charge account card, etc. In some embodiments, the access device may require the user to enter a passcode (e.g. a PIN) associated with the payment device (e.g. in case of the debit card) before proceeding with the transaction. In some embodiments, the transition terminal may require approval from the user to process the transaction as a real-time transaction (e.g. OCT processing). According to various embodiments, the resource provider may offer incentives for the user to approve processing of the transaction as a real-time transaction.

The access device 202 may retrieve account credentials such as an account identifier (e.g. a first account identifier), expiration date of the payment device, user name, etc. directly from the payment device and may transmit the account credentials along with transaction data (e.g. an amount of the transaction, service or goods being purchased, transaction time) to a resource provider computer 204. The resource provider computer 204 may forward the information received from the access device 202 as well as an account identifier identifying the resource provider (e.g. a second account identifier) to a transport computer 206 requesting authorization for the transaction.

According to various embodiments, the second account identifier (e.g. the resource provider account number) may be an account identifier created for the associated resource provider by the processing server computer. In some embodiments, the second account identifier may be a virtual PAN for the resource provider. The virtual PAN may be a restricted account number that is only valid for depositing funds. The virtual PAN may identify an account of the resource provider at the transport entity. The resource provider may withdraw the funds from their account, for example, in person.

The transport computer 206 may receive information associated with the transaction that is initiated at the access device of the resource provider. The information may include account credentials and the transaction data. The transport computer 206 may identify that the resource provider and the transaction are eligible for joint processing for authorization and settlement. The transport computer may then generate a hybrid request message including a request to authorize and settle the transaction in a single message. The hybrid request message requests (1) authorization for the transaction, and (2) crediting an account of the resource provider with the funds associated with the transaction. The hybrid request message may include a first account identifier (e.g. a primary account number (PAN) of the user), a second account identifier (e.g. a resource provider account number), a processing code identifying the access device transaction for hybrid processing, and other information required for identifying the user and the resource provider.

In some embodiments, the resource provider computer 204 may send the account credentials and the transaction data in form of a transaction authorization request message to the transport computer 206. In such embodiments, the transport computer 206 may indicate that the resource provider and the transaction are eligible for joint processing for authorization and settlement. The transport computer 206 may then format the transaction authorization request message received from the resource provider computer 204 as a hybrid request message.

The transport computer 206 may transmit the hybrid request message to the processing server computer 208, which then transmits the hybrid request message to the authorizing authority computer 210.

Upon receiving the hybrid request message, the authorizing authority computer 210 may identify the hybrid processing code in the message to distinguish it from other conventional authorization request messages. The hybrid processing code may indicate a request for joint processing for authorization and settlement. The authorizing authority computer 210 may then determine (based on various factors, such as a risk assessment score associated with the consumer or the resource provider) whether one or more of the transaction, the account holder or the resource provider qualify for joint authorization and settlement processing. For example, the authorizing authority computer may determine a level of activity within a predetermined period of time in the user's account, amount of funds on reserve for the user, a type of the transaction (e.g. credit transaction, debit transaction, etc.), a risk assessment score associated with the user account and/or the access device in determining whether or not to proceed with hybrid processing.

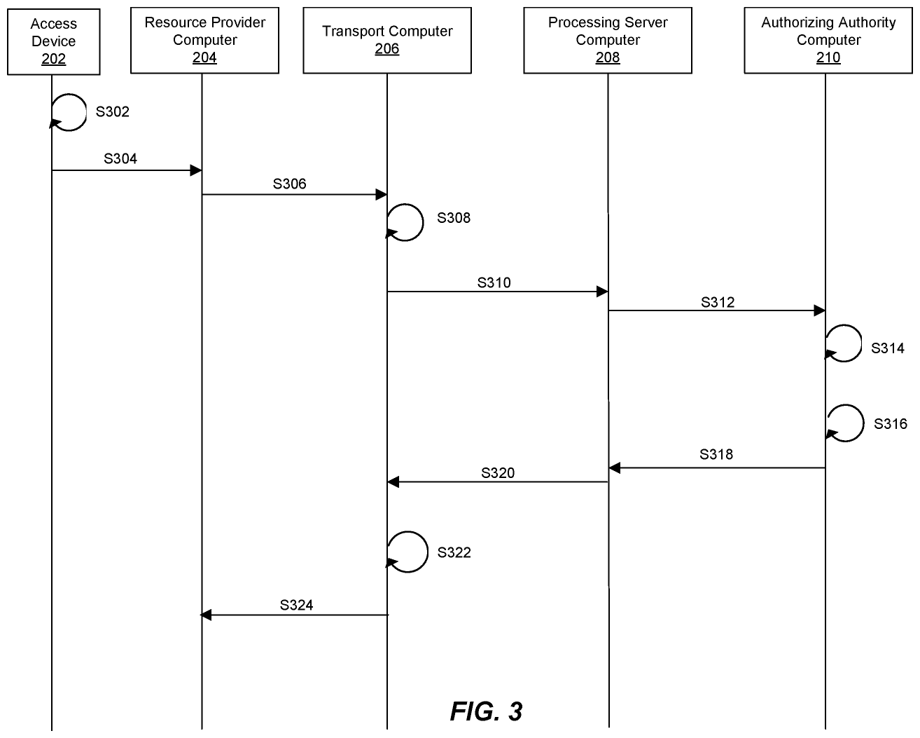

If it is determined that one or more of the transaction, the account holder or the resource provider qualifies for joint authorization and settlement processing, the authorizing authority computer 210 may perform joint processing for authorization and settlement, as requested in the hybrid request message. This process is illustrated in FIGS. 2-3. In some embodiments, the authorizing authority computer 210 may require that all of the transaction, the account holder and the resource provider qualify for joint authorization and settlement processing before proceeding with joint processing.

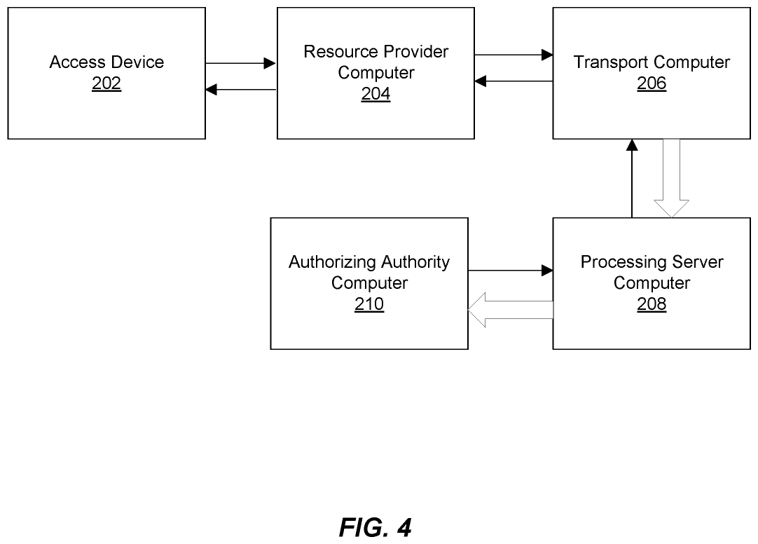

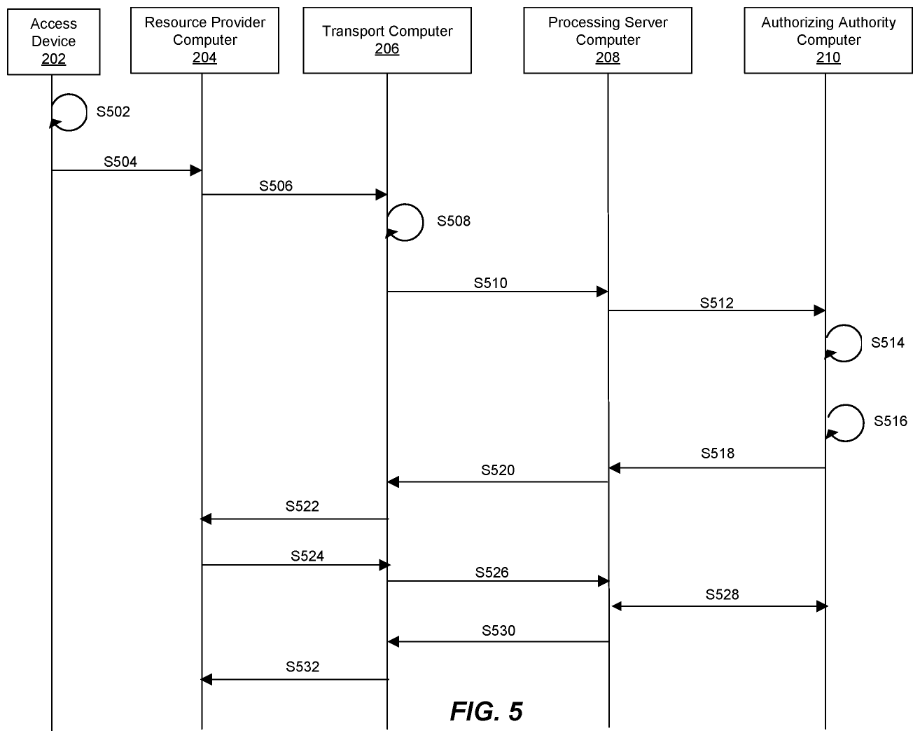

If, on the other hand, it is determined that one or more of the transaction, the account holder or the resource provider does not qualify for joint authorization and settlement processing, the authorizing authority computer 210 may process the hybrid request message as a transaction authorization request message and reply with an authorization request response message first, and then handle clearing and settlement 24-72 hours later. In this process, the transport computer 206 will initiate the settlement process with the processing server computer or the authorizing authority within 24-72 hours later after receiving the authorization request response message from the authorizing authority computer 210. This process is illustrated in FIGS. 4-5.

Referring back to FIG. 2, upon determining that one or more of the transaction, the account holder or the resource provider qualify for joint authorization and settlement processing, the authorizing authority computer 210 may generate a hybrid response message including an indicator that the transaction is authorized and an instruction to settle with the resource provider. For example, the instruction to settle may be in form of a code provided both by the use of the Hybrid Message Type Identifier, and other codes in dedicated data fields of the hybrid response message. The transport entity may be programmed to interpret the code as an instruction to credit an account of the resource provider in an amount indicated in the hybrid response message or in the amount of the transaction. The authorizing authority computer 210 may transmit the hybrid response message to the transport computer 206 via the processing server computer 208.

The transport computer 206 receives the hybrid response message from the authorizing authority computer 210 via the processing server computer 208. The hybrid response message may include an indicator that the transaction is authorized by the authorizing authority computer 210, as well as an instruction to settle with the resource provider.

The transport computer 206 may accept the incoming hybrid response (e.g. OCT Response) and may credit an account of the resource provider identified by the second identifier in the amount of the transaction or in any other amount that is authorized by the authorizing authority computer 210. The account of the resource provider may be credited in real time or shortly after the transaction is initiated (e.g. within a predetermined amount of time, 1 minute, 5 minutes, 15 minutes, 30 minutes, or 60 minutes upon completion of the transaction). In some embodiments, the transport computer 206 may notify the resource provider that the account of the resource provider has been credited.

According to various embodiments, the processing server computer 208 may update records on a database indicating that the transaction has been processed as a real-time transaction (e.g. OCT transaction) and that the authorizing authority already debited the user's account and the transport computer credited the resource provider account. Accordingly, the processing server computer will know that no clearing and settlement will be required/performed for this transaction (e.g. the transaction may be marked as already cleared and settled).

FIG. 3 is a flowchart of an exemplary method for hybrid processing of access device transactions according to various embodiments of the present invention. At step S302, the access device 202 may receive account credentials such as account identifier (e.g. a first account identifier), expiration date of the payment device, user name, etc. from a payment device presented to the access device 202. The access device 202 may read the account credentials from a memory or a magnetic strip of a payment device. In some embodiments, the access device 202 may receive the account credentials via near-field communication (NFC) with the payment device. At step S304, the access device 202 may transmit the account credentials along with transaction data (e.g. an amount of the transaction, service or goods being purchased, transaction time) to a resource provider computer 204.

At step S306, the resource provider computer 204 may forward the information received from the access device 202 as well as an account identifier identifying the resource provider (e.g. a second account identifier) to a transport computer 206 requesting authorization for the transaction. The second account identifier (e.g. the resource provider account number) may be a virtual PAN created for the resource provider by the processing server computer.

At step S308, the transport computer 206 may identify that the resource provider and the transaction are eligible for joint processing for authorization and settlement and generate a hybrid request message including a request to authorize and settle the transaction in a single message. The hybrid request message may be in ISO 8583 financial transaction message format. The hybrid request message may include a first account identifier (e.g. a primary account number (PAN) of the user), a second account identifier (e.g. the virtual PAN created for the resource provider by the processing server computer), a processing code identifying the access device transaction for hybrid processing, and other information required for identifying the user and the resource provider. For example, the second account identifier may be included in a data field of the ISO 8583 message (e.g. in data field F104).

At step S310, the transport computer 206 may transmit the hybrid request message to the processing server computer 208. At step S312, the processing server computer 208 may transmit the hybrid request message to the authorizing authority computer 210.

At step S314, the authorizing authority computer 210 may identify the hybrid processing code in the message to distinguish it from other conventional authorization request messages. The hybrid processing code may indicate a request for joint processing for authorization and settlement. The authorizing authority computer 210 may then analyze the hybrid request message to determine whether one or more of the transaction, the account holder or the resource provider qualify for joint authorization and settlement processing. The determination may be based on various factors, such as a risk assessment score associated with the consumer or the resource provider. For example, the authorizing authority computer may determine a level of activity within a predetermined period of time in the user's account, amount of funds on reserve for the user, a type of the transaction (e.g. credit transaction, debit transaction, etc.), a risk assessment score associated with the user account and/or the access device in determining whether or not to proceed with hybrid processing. For instance, if a transaction has a high probability of being legitimate and being completed, then the transaction may be suitable for rapid settlement processing using an OCT message.

At step S316, the authorizing authority computer 210 may determine to proceed with joint authorization and settlement, and generates a hybrid response message including an indicator that the transaction is authorized and an instruction to settle with the resource provider. When the authorizing authority computer 210 proceeds with joint authorization and settlement, to credit the resource provider account in real time or shortly after initiation of the transaction (or in near real time, such as within 5 min, 15 min, 30 min, 60 min), the authorizing authority computer 210 generates a push funds authorization response message (e.g. ISO 8583 message type 0130, Response Code ‘OC’).

At steps S318-S320, the authorizing authority computer 210 may transmit the hybrid response message to the transport computer 206 via the processing server computer 208.

At step S322, the transport computer 206 processes the hybrid response message (e.g. OCT Response) and credits the account of the resource provider identified by the second identifier in the amount of the transaction or in any other amount that is authorized by the authorizing authority computer 210.

At step S324, the transport computer 206 informs the resource provider computer 204 that the transaction has been authorized and that he account of the resource provider is credited in real time or shortly after the transaction is initiated (e.g. within a predetermined amount of time, 30 minutes, or 60 minutes upon completion of the transaction).

Using the process described in connection with FIGS. 3-4, the resource provider may receive the payment for the goods or services provided to the user within (e.g., less than) 1 minute, 5 minutes, 15 minutes, 30 minutes, or 60 minutes of providing the goods or services. In addition, the hybrid processing discussed herein eliminates the secondary message steam between the entities for clearing and settlement. The transaction is authorized, cleared and settled in a single message stream. Thus, embodiments described in FIGS. 3-4 save time and processing power at various entities (e.g. the transport entity, the processing server computer, and the authorizing entity).

Alternatively, as explained according to various embodiments, the authorizing entity computer may choose to process the hybrid request message requesting joint processing for transaction authorization and settlement as a standard authorization request message. The push funds authorization request message may request the authorizing entity computer to validate that the account holder details are correct, that there are sufficient funds in the account holder's account, and if the authorizing entity computer approves the transaction as a conventional card-present transaction (e.g. POS transaction), to reply with a conventional authorization response message (e.g. ISO 8583 message type 0110 Response code ‘00’).

FIG. 4 illustrates a block diagram of an exemplary system for hybrid authorization request of access device transactions according to various embodiments of the present invention. A user may initiate a transaction with a resource provider by presenting a physical payment device to an access device (e.g. transaction terminal) associated with the resource provider.

The access device 202 may retrieve account credentials such as account identifier (e.g. a first account identifier), expiration date of the payment device, user name, etc. directly from the payment device and may transmit the account credentials along with transaction data (e.g. an amount of the transaction, service or goods being purchased, transaction time) to a resource provider computer 204. The resource provider computer 204 may forward the information received from the access device 202 as well as an account identifier identifying the resource provider (e.g. a second account identifier) to a transport computer 206 requesting authorization for the transaction.

According to various embodiments, the second account identifier (e.g. the resource provider account number) may be an account identifier created for the associated resource provider by the processing server computer. In some embodiments, the second account identifier may be a virtual PAN for the resource provider. The virtual PAN may be a restricted account number that is only valid for depositing funds. The virtual PAN may identify an account of the resource provider at the transport entity. The resource provider may withdraw the funds from their account, for example, in person.

The transport computer 206 may receive information associated with the transaction that is initiated at the access device of the resource provider. The information may include account credentials and the transaction data. The transport computer 206 may identify that the resource provider and the transaction are eligible for joint processing for authorization and settlement. The transport computer may then generate a hybrid request message including a request to authorize and settle the transaction in a single message. The hybrid request message requests (1) authorization for the transaction, and (2) crediting an account of the resource provider with the funds associated with the transaction. The hybrid request message may include a first account identifier (e.g. a primary account number (PAN) of the user), a second account identifier (e.g. a resource provider account number), a processing code identifying the access device transaction for hybrid processing, and other information required for identifying the user and the resource provider.

In some embodiments, the resource provider computer 204 may send the account credentials and the transaction data in form of a transaction authorization request message to the transport computer 206. In such embodiments, the transport computer 206 may identify that the resource provider and the transaction are eligible for joint processing for authorization and settlement. The transport computer 206 may then format the transaction authorization request message received from the resource provider computer 204 into a hybrid request message.

The transport computer 206 may transmit the hybrid request message to the processing server computer 208, which then transmits the hybrid request message to the authorizing authority computer 210.

Upon receiving the hybrid request message, after determining that the hybrid request message is not a standard authorization request message from the processing code in the hybrid request message, the authorizing authority computer 210 may determine (based on various factors, such as a risk assessment score associated with the consumer or the resource provider) whether one or more of the transaction, the account holder or the resource provider qualify for joint authorization and settlement processing. For example, the authorizing authority computer may determine a level of activity within a predetermined period of time in the user's account, amount of funds on reserve for the user, a type of the transaction (e.g. credit transaction, debit transaction, etc.), a risk assessment score associated with the user account and/or the access device in determining whether or not to proceed with hybrid processing. For instance, if a transaction has a medium probability of being legitimate and being completed, then the transaction may be suitable for rapid normal authorization processing without using rapid settlement processing. If the transaction has a very low probability of being legitimate and being completed, then the authorizing authority computer 210 may decline the transaction.

When the authorizing authority computer 210 determines that one or more of the transaction, the account holder or the resource provider does not qualify for joint authorization and settlement processing, the authorizing authority computer 210 may process the hybrid request message as a normal transaction authorization request message. The authorizing authority computer 210 may authorize the transaction and generate an authorization response message including an indicator that the transaction is authorized. The authorizing authority computer 210 may transmit the authorization response message to the transport computer 206 via the processing server computer 208.

The transport computer 206 receives the authorization response message from the authorizing authority computer 210 via the processing server computer 208. The authorization response message may include an indicator that the transaction is authorized by the authorizing authority computer 210. The transport computer 206 may notify the resource provider computer 204 that the transaction is authorized, and the resource provider may release the goods or services to the user. At a later time, the resource provider computer 204 initiates a clearing and settlement process with the transport computer 206 and the processing server computer 208. The authorizing authority computer 210 receives a separate request message to settle the transaction. The authorizing authority computer 210 sends an instruction message to the transport computer to credit an account of the resource provider. The account of the resource provider may be credited one to a few days after the goods or services are released to the user.

FIG. 5 is a flowchart of an exemplary method for hybrid authorization request of access device transactions according to various embodiments of the present invention. Steps S502-S514 of FIG. 5 are identical to steps S302-S314 of FIG. 3. The description of steps S502-S514 of FIG. 5 are omitted for purposes of brevity.

At step S516, the authorizing authority computer 210 may determine that one or more of the transaction, the account holder or the resource provider does not qualify for joint authorization and settlement processing, and that the hybrid request message should be processed as an authorization request message. The authorizing authority computer 210 may authorize the transaction and generate an authorization response message including an indicator that the transaction is authorized. The authorizing authority computer 210 may transmit the authorization response message to the transport computer 206 via the processing server computer 208.

At steps S518-S520, the authorizing authority computer 210 may transmit the authorization response message to the transport computer 206 via the processing server computer 208.

At step S522, the transport computer 206 notifies the resource provider computer 204 that the transaction is authorized, and the resource provider may release the goods or services to the user.

At steps S524-S526 occurring some time after the goods or services are released to the user, the resource provider computer 204 sends a list of one or more transactions (e.g. a batch of transactions) to the transport computer 206 for settlement. The transport computer may receive the request for settlement from the computer of the resource provider; and initiate a settlement process (e.g. a clearing and settlement process) with the processing server computer 208.

At step S528, the authorizing authority computer 210 receives a separate request message to settle the transaction. The settlement request message may include an account identifier identifying an account of the resource provider, and a total amount of one or more transactions that need settling and clearing. The authorizing authority computer 210 sends an instruction message to the transport computer to credit an account of the resource provider. The account of the resource provider may be credited one to a few days after the goods or services are released to the user.

At step S530, the transport computer 206 receives instruction to credit an account of the resource provider identified in the clearing and settlement request in the amount authorized by the authorizing authority computer 210, and processes the instruction.

At step S532, the transport computer 206 notifies the resource provider that their account has been credited in the amount authorized by the authorizing authority computer 210.

Although the steps in the flowcharts and process flows described above are illustrated or described in a specific order, it is understood that embodiments of the invention may include methods that have the steps in different orders. In addition, steps may be omitted or added and may still be within embodiments of the invention.

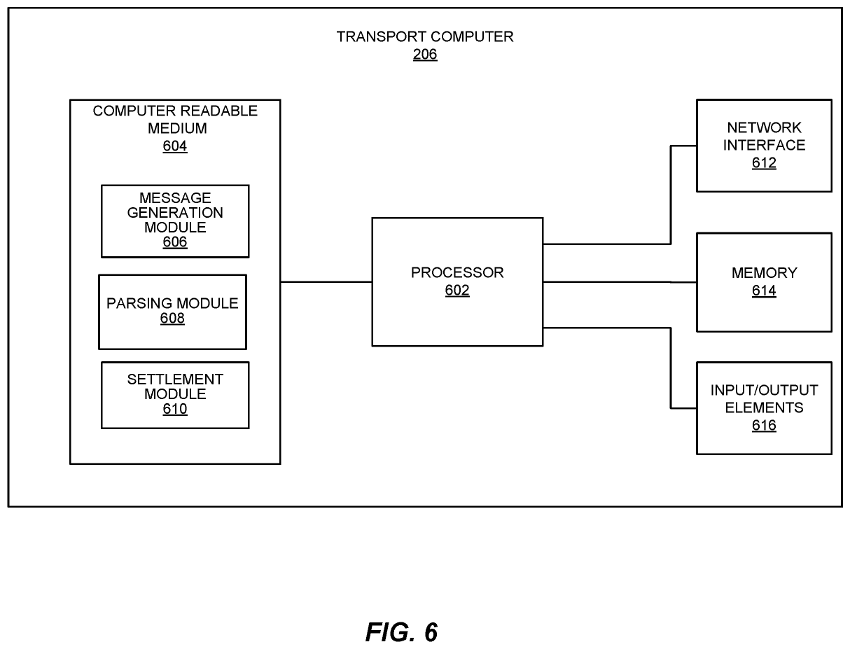

FIG. 6 is a block diagram of an exemplary transport computer according to various embodiments of the present invention. The exemplary transport computer 206 may comprise a processor 602. The processor 602 may be coupled to a memory 614, a network interface 612, input/output elements 616, and a computer readable medium 604. The computer readable medium 604 can comprise a message generation module 606, a parsing module 608 and a settlement module 610. The message generation module 605, in conjunction with the processor 602, may generate an authorization request message or a hybrid request message. The parsing module 608, in conjunction with the processor 602, can parse incoming data from an access device to generate an authorization request or hybrid request message. The settlement module 610, in conjunction with the processor 602, can perform clearing and settlement processing on behalf of the transport computer 206.

The memory 614 can be used to store data and code. The memory 614 may be coupled to the processor 602 internally or externally (e.g., cloud based data storage), and may comprise any combination of volatile and/or non-volatile memory, such as RAM, DRAM, ROM, flash, or any other suitable memory device.

The network interface 612 may include an interface that can allow the exemplary transport computer 206 to communicate with external computers. Network interface 612 may enable the exemplary transport computer 206 to communicate data to and from another device (e.g., resource provider computer, processing server computer, authorizing authority computer, etc.). Some examples of network interface 612 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by network interface 612 may include Wi-Fi™. Data transferred via network interface 612 may be in the form of signals which may be electrical, electromagnetic, optical, or any other signal capable of being received by the external communications interface (collectively referred to as “electronic signals” or “electronic messages”). These electronic messages that may comprise data or instructions may be provided between network interface 612 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium. The network interface 612 can utilize a long range communication channel as well as a short range communication channel.

The one or more input/output elements 616 include any suitable device(s) capable of inputting data into the exemplary transport computer 206 such as buttons, touchscreens, touch pads, microphones, etc. or outputting data from the exemplary transport computer 206.

The computer readable medium 604 may comprise code, executable by the processor, for performing a method comprising: receiving, from a computer of a resource provider, information associated with a transaction initiated at an access device associated with the resource provider; identifying that the resource provider and the transaction are eligible for joint processing for authorization and settlement; generating, for example using the message generation module 606, a hybrid request message including a request to authorize and settle the transaction in a single message; transmitting the hybrid request message a processing server computer; receiving a response message including an indicator that the transaction is authorized by an authorizing authority computer; analyzing, for example using the parsing module 608, the response message for a hybrid processing code indicating a request for joint processing of the transaction for authorization and settlement; transmitting an authorization response message including the indicator that the transaction is authorized to the computer of the resource provider; and settling, for example using the settlement module 610, with the resource provider.

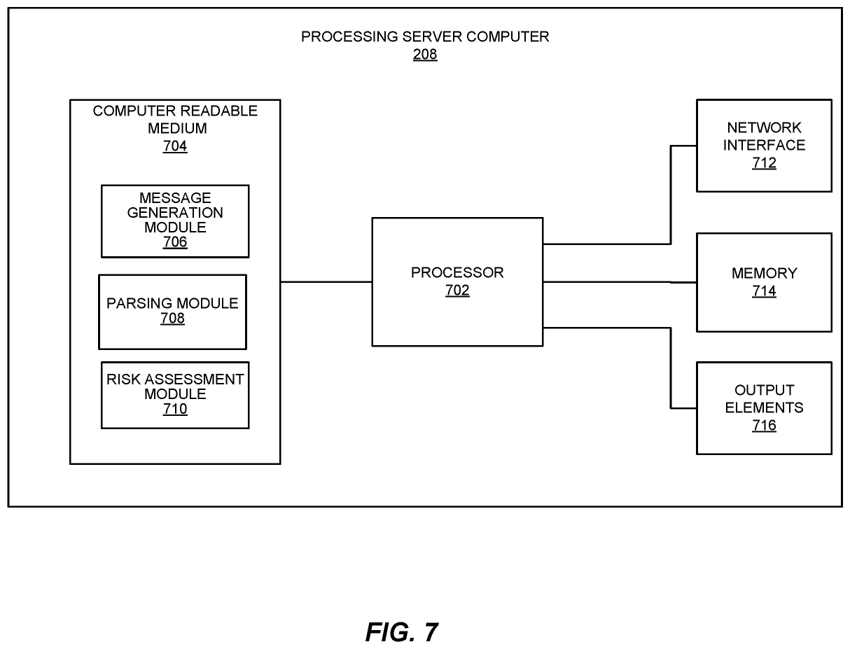

FIG. 7 is a block diagram of an exemplary processing server computer according to various embodiments of the present invention. The exemplary processing server computer 208 may comprise a processor 702. The processor 702 may be coupled to a memory 714, a network interface 712, input/output elements 716, and a computer readable medium 704. The computer readable medium 704 can comprise a message generation module 706, a parsing module 708 and a risk assessment module 710. The parsing module 708, in conjunction with the processor 702, can parse incoming data from the authorization request message or the hybrid request message received from the transport computer 206. If the processing server computer 208 identifies a token during parsing, the message generation module 706, in conjunction with the processor 702, may generate a modified authorization request message or a modified hybrid request message that includes an actual account identifier for the account identified by the token. The risk assessment module 710, in conjunction with the processor 702, can perform risk assessment for one or more of the transaction, the account holder or the account used in the transaction and determine a risk assessment score. The risk assessment score may be included in the modified authorization request message or the modified hybrid request message that is transmitted to the authorizing authority computer.

The memory 714 can be used to store data and code. The memory 714 may be coupled to the processor 702 internally or externally (e.g., cloud based data storage), and may comprise any combination of volatile and/or non-volatile memory, such as RAM, DRAM, ROM, flash, or any other suitable memory device.

The network interface 712 may include an interface that can allow the exemplary processing server computer 208 to communicate with external computers. Network interface 712 may enable the exemplary processing server computer 208 to communicate data to and from another device (e.g., transport computer, authorizing authority computer, etc.). The network interface 712 is similar to network interface 612. Therefore, further description of the network interface 712 is omitted for purposes of brevity.

The one or more input/output elements 716 include any suitable device(s) capable of inputting data into the exemplary processing server computer 208 such as buttons, touchscreens, touch pads, microphones, etc. or outputting data from the exemplary processing server computer 208.

The computer readable medium 704 may comprise code, executable by the processor, for performing a method comprising: receiving, from a transport computer, a hybrid request message including information associated with a transaction initiated at an access device associated with a resource provider; determining, for example using the risk assessment module 710, a risk assessment score for one or more of the transaction, the access device, an account holder of an account used in the transaction or the account itself; generating, for example using the message generation module 706, a hybrid request message including at least the risk assessment score and a request to authorize and settle the transaction in a single message; transmitting the hybrid request message an authorizing entity computer; receiving a response message including an indicator that the transaction is authorized by the authorizing authority computer; analyzing, for example using the parsing module 708, the response message for a hybrid processing code indicating a request for joint processing of the transaction for authorization and settlement; transmitting the authorization response message including the indicator that the transaction is authorized and an instruction to settle with the resource provider to the transport computer.

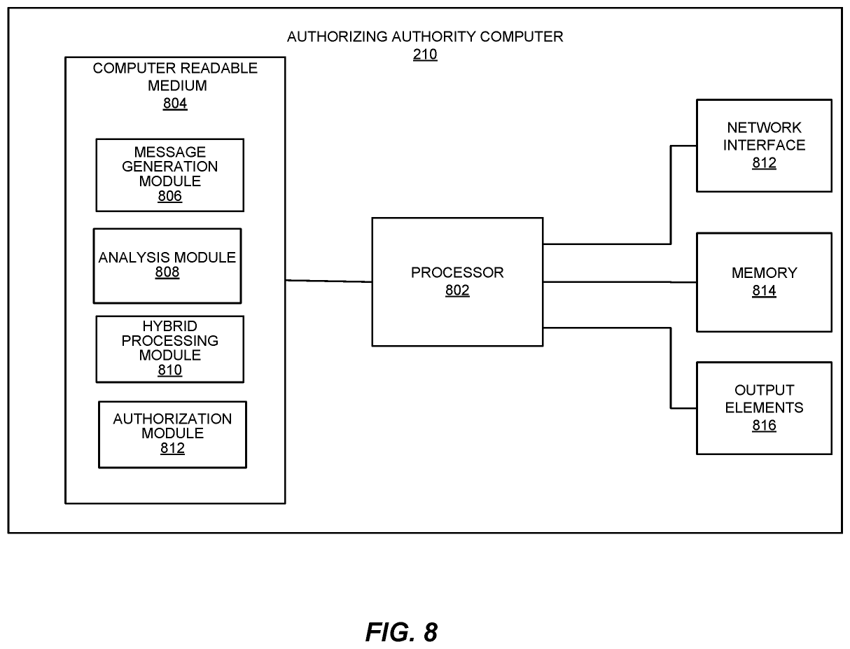

FIG. 8 is a block diagram of an exemplary authorizing authority computer according to various embodiments of the present invention. The exemplary authorizing authority computer 210 may comprise a processor 802. The processor 802 may be coupled to a memory 814, a network interface 812, input/output elements 816, and a computer readable medium 804. The computer readable medium 804 can comprise a message generation module 806, an analysis module 808, a hybrid processing module 810, and an authorization module 812. The analysis module 808, in conjunction with the processor 802, can parse incoming data from the modified authorization request message or the modified hybrid request message received from the processing server computer 208 to identify the risk assessment score and a hybrid processing code.

If the analysis module 808, in conjunction with the processor 802, identifies the hybrid processing code, the transaction may be processed by the hybrid processing module 810. The hybrid processing module 810, in conjunction with the processor 802, may perform the joint authorization and settlement of the transaction based on the risk assessment score (e.g. if the risk assessment score is above a predetermined threshold, the transaction may qualify for joint authorization and settlement, otherwise, the transaction may be declined). Then, the message generation module 806, in conjunction with the processor 802, may generate a hybrid response message including an indicator that the transaction is authorized, and including an instruction for the transport entity to settle with the resource provider. If the transaction is declined, a normal transaction authorization response message maybe generated including an indicator that the transaction is declined.

If the analysis module 808, in conjunction with the processor 802, does not identify the hybrid processing code and/or identifies a normal processing code, the transaction may be processed by the authorization module 812. The authorization module 812, in conjunction with the processor 802, may determine whether the transaction is to be authorized or declined. Then, the message generation module 806, in conjunction with the processor 802, may generate a normal authorization response message including an indicator that the transaction is authorized or declined.

The memory 814 can be used to store data and code. The memory 814 may be coupled to the processor 802 internally or externally (e.g., cloud based data storage), and may comprise any combination of volatile and/or non-volatile memory, such as RAM, DRAM, ROM, flash, or any other suitable memory device.

The network interface 812 may include an interface that can allow the exemplary authorizing authority computer 210 to communicate with external computers. Network interface 812 may enable the exemplary authorizing authority computer 210 to communicate data to and from another device (e.g., resource provider computer, processing server computer, transport computer, etc.). The network interface 812 is similar to network interface 612. Therefore, further description of the network interface 812 is omitted for purposes of brevity.

The one or more input/output elements 816 include any suitable device(s) capable of inputting data into the exemplary authorizing authority computer 210 such as buttons, touchscreens, touch pads, microphones, etc. or outputting data from the exemplary authorizing authority computer 210.

The computer readable medium 804 may comprise code, executable by the processor, for performing a method comprising: receiving a hybrid request message requesting approval for a transaction between an account holder and a resource provider, wherein the hybrid request message includes a request for joint authorization and settlement for the transaction; analyzing, for example using the analysis module 808, the hybrid request message; identifying a risk assessment score in the hybrid analysis module, determining whether one or more of the transaction, the account holder or the resource provider qualifies for joint authorization and settlement processing based on at least the risk assessment score.

If the one or more of the transaction, the account holder or the resource provider qualifies for joint authorization and settlement processing based on at least the risk assessment score, the method further comprises: jointly processing, for example using the hybrid processing module 810, authorization and settlement of the transaction; generating, for example using the message generation module 806, a hybrid response message including an identifier indicating that the transaction is authorized and an instruction for the transport computer to credit an account of the resource provider computer in an authorized amount; and transmitting the hybrid response message to a transport computer in communication with a computer of the resource provider.

If the one or more of the transaction, the account holder or the resource provider does not for joint authorization and settlement processing based on at least the risk assessment score, the method further comprises: authorizing, for example using the authorization module 812, the transaction; generating, for example using the message generation module 806, an authorization response message including an identifier indicating that the transaction is authorized; and transmitting the authorization response message to a transport computer in communication with a computer of the resource provider. A clearing and settlement process is performed thereafter.

Embodiments provide a number of technical advantages. Embodiments allow for hybrid processing (e.g. joint authorization and settlement) of access device transactions. The hybrid processing eliminates a second stream of messages (e.g. clearing and settlement processing messages) being generated and transmitted amount entities in a transaction processing ecosystem. Therefore, embodiments result in increased efficiency of computer of various entities (e.g. resource providers, transport entities, transaction processors, and/or authorizing authorities) by reserving processing power of these computers for other processes.

Embodiments further reduce fraud associated with handling funds transfer by crediting an account of a resource provider and amounts authorized by an authorizing authority shortly after completing a transaction. The authorizing entity instructs the transport entity to credit an account of the resource provider along with authorizing the transaction. While this allows for the resource providers having access to the funds associated with the transactions immediately following the transactions, it also eliminates responsibilities or liabilities of the transport computer, transaction processor, and/or authorizing authority associated with storing funds that are assigned to a different entity (e.g. the resource provider). Thus, resource providers can easily receive payments for services or goods they provided to consumers in a secure, efficient and fast manner.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method comprising:
receiving, at a transport computer from a computer of a resource provider, information associated with a transaction initiated at an access device associated with the resource provider;
identifying, by the transport computer, that the resource provider and the transaction are eligible for joint processing for authorization and settlement;
generating, by the transport computer, a hybrid request message including a request to authorize and settle the transaction in a single message;
transmitting, by the transport computer, the hybrid request message to a processing server computer;
receiving, by the transport computer, a response message including an indicator that the transaction is authorized by an authorizing authority computer;
transmitting, by the transport computer, an authorization response message including the indicator that the transaction is authorized to the computer of the resource provider; and
settling, by the transport computer, with the resource provider.

2. The method of claim 1, wherein information associated with the transaction includes an account identifier received at the access device directly from a payment device.

3. The method of claim 1, wherein the information associated with the transaction includes one or more of an amount of transaction, a first account identifier identifying an account of a user, and a second account identifier identifying an account of the resource provider.

4. The method of claim 1, wherein the response message is a hybrid response message including the indicator that the transaction is authorized and an instruction to settle with the resource provider.

5. The method of claim 4, wherein the settling with the resource provider comprises:
crediting, by the transport computer, an account of the resource provider in an amount authorized by the authorizing authority computer within 60 minutes upon receiving the hybrid response message.

6. The method of claim 1, wherein the response message is the authorization response message, and the method further includes, after transmitting the authorization response message to the computer of the resource provider:
receiving, by the transport computer from the processing server computer, a settlement message including an instruction to settle with the resource provider.

7. The method of claim 1, wherein the generating the hybrid request message includes adding a hybrid processing code indicating a request for joint processing for authorization and settlement.

8. The method of claim 1, further comprising, after receiving the response message:
analyzing the response message for a hybrid processing code indicating joint processing of the transaction for authorization and settlement.

9. The method of claim 1, wherein settling with the resource provider comprises:
crediting an account of the resource provider in an amount authorized by the authorizing authority computer.

10. The method of claim 1, wherein the information associated with the transaction includes a user selection of hybrid processing of the transaction.

11. A transport computer comprising:
a processor; and
a computer readable medium comprising code, executable by the processor, for implementing a method comprising:
receiving, from a computer of a resource provider, information associated with a transaction initiated at an access device associated with the resource provider;
identifying that the resource provider and the transaction are eligible for joint processing for authorization and settlement;
generating a hybrid request message indicating a request to authorize and settle the transaction in a single message;
transmitting the hybrid request message a processing server computer;
receiving a response message including an indicator that the transaction is authorized by an authorizing authority computer;
transmitting an authorization response message including the indicator that the transaction is authorized to the computer of the resource provider; and
settling with the resource provider.

12. The transport computer of claim 11, wherein the hybrid request message includes a transaction amount, a first account identifier identifying an account to be debited, and a second account identifier identifying an account of the resource provider to be credited.

13. The transport computer of claim 11, wherein the response message is a hybrid response message including an instruction to settle with the resource provider in addition to the indicator that the transaction is authorized.

14. The transport computer of claim 11, wherein the response message is the authorization response message, and the method further includes, after transmitting the authorization response message to the computer of the resource provider:
receiving a request for settlement from the computer of the resource provider; and
initiating a settlement process with the processing server computer.

15. The transport computer of claim 11, wherein the hybrid request message includes a hybrid processing code indicating a request for joint processing for authorization and settlement.

16. The transport computer of claim 11, wherein the access device is a point of sale terminal that is configured to receive payment information directly from a payment device.

17. A method comprising:
receiving, at an authorizing authority computer, a hybrid request message requesting approval for a transaction between an account holder and a resource provider, wherein the hybrid request message includes a request for joint authorization and settlement for the transaction;
determining, by the authorizing authority computer, that one or more of the transaction, the account holder or the resource provider does not qualify for joint authorization and settlement processing;
authorizing, by the authorizing authority computer, the transaction;
generating, by the authorizing authority computer, an authorization response message including an identifier indicating that the transaction is authorized; and
transmitting, by the authorizing authority computer, the authorization response message to a transport computer in communication with a computer of the resource provider.

18. The method of claim 17, wherein the determining that one or more of the transaction, the account holder or the resource provider does not qualify for joint authorization and settlement processing is based on a risk assessment score.

19. The method of claim 17, wherein the hybrid request message includes a transaction amount, a first account identifier identifying an account to be debited, and a second account identifier identifying the account of the resource provider to be credited.

20. The method of claim 17, further comprising:
after transmitting the authorization response message, receiving, by the authorizing authority computer, a request message to settle the transaction; and
sending an instruction message to the transport computer to credit an account of the resource provider.
